(19) United States
(12) Patent Application Publication
(10) Pub. No.: US 2013/0169101 A1
(43) Pub. Date: Jul. 4, 2013

(54) Permanent Magnet Rotor With Intrusion

(71) Applicants: Fang Deng, Novi, MI (US); Ghanshyam Shrestha, Northville, MI (US)

(72) Inventors: Fang Deng, Novi, MI (US); Ghanshyam Shrestha, Northville, MI (US)

(73) Assignee: Danotek Motion Technologies, Inc., Canton, MI (US)

(21) Appl. No.: 13/559,323

(22) Filed: Jul. 26, 2012

Related U.S. Application Data
(60) Provisional application No. 61/581,605, filed on Dec. 29, 2011.

(51) Int. Cl. H02K 1/17

(52) U.S. Cl. 310/156.53

(57) ABSTRACT

A rotor for an electric machine is provided that includes a magnet and a non-magnetic region located adjacent the magnet. The non-magnetic region has an intrusion extending into the non-magnetic region.

### CROSS REFERENCE TO RELATED APPLICATIONS

This application claims the benefit of U.S. Provisional Patent Application No. 61/581,605 filed Dec. 29, 2011, the content of which is hereby incorporated by reference in its entirety.

### BACKGROUND

The present application generally relates to improving operation of a rotor for power generation.

### SUMMARY

In some implementations, a rotor for an electric machine, such as an electric generator, may be provided. The rotor may include a magnet. The rotor may also include a non-magnetic region located adjacent to the magnet. The rotor may further include an intrusion extending into the non-magnetic region.

In some implementations, the rotor may include a first magnet and a second magnet. The rotor may also include a non-magnetic region located between a first end of the first magnet and a second end of the second magnet. The rotor may further include an intrusion extending into the non-magnetic region.

In some implementations, a rotor structure is provided that is configured to increase reluctance torque, the rotor structure including an intrusion in a non-magnetic region that is located between two magnets.

Further objects, features and advantages of this application will become readily apparent to persons skilled in the art after a review of the following description, with reference to the drawings and claims that are appended to and form a part of this specification.

### BRIEF DESCRIPTION OF THE DRAWINGS

The drawings described herein are for illustration purposes only and are not intended to limit the scope of the present disclosure in any way.

FIG. 1 is a front view of an embedded permanent magnet synchronous machine with eight excitation magnetic field generating portions;

FIG. 2 is a front view of the interior permanent magnet synchronous machine having two excitation magnetic field generating portions in a rotor with an intrusion in a non-magnetic region to improve magnetic characteristics of the magnetic machine; and

FIG. 3 is a front view of two excitation magnetic field generating portions in another rotor with an intrusion into non-magnetic regions to improve magnetic characteristics of the magnetic machine.

It should be understood that throughout the drawings, corresponding reference numerals indicate like or corresponding parts and features.

### DETAILED DESCRIPTION

The term “about” or “generally” used herein with reference to a shape or quantity includes variations in the recited shape or quantity that are equivalent to the shape for an intended purpose or function.

A permanent magnet machine may be embodied as either a non-salient machine or a salient machine. The salient machine may have a quadrature axis electromagnetic circuit provided to increase output power. In general, a generator is a device that generates electric power by an interacting electromagnetic force between a rotational part (rotor) and a stationary part (stator). The rotor may include an electromagnet (e.g. field coil) around a rotor-core, or permanent magnets on the surface or inside rotor-core to provide rotational magnetic flux, for example. The stator may include an armature coil around a stator core, for example. The magnet in the rotor may induce electric voltage in the armature coil of the stator.

One class of generators includes permanent magnet synchronous machines, which includes both the non-salient and salient types differing principally in the relative utilization of the two components of torque. The two components include the fundamental alignment torque (electromechanical torque) and the second harmonic reluctance torque. The reluctance torque is a function of the saliency ratio e.g. a ratio of quadrature axis synchronous inductance (L_{q}) to direct axis synchronous inductance (L_{d}), as is known in the art. In a non-salient machine—typically having surface mount magnets—L_{d} is nearly equal to L_{q}, thus the saliency ratio is close to 1. Accordingly, the reluctance torque is negligible. However intrusion of core material in the quadrature axis will increase the saliency ratio, therefore, increasing the reluctance torque and total output torque.

Permanent magnet synchronous machines may be used in wind turbine applications. In these applications, the permanent magnet synchronous machines may be connected to the grid with a back to back converter and the maximum voltage the generator can produce may be limited by the rating of the capacitor of the converter. The requirement for over voltage conditions can, therefore, be very strict, requiring the generator open circuit voltage to be very low compared to the generator terminal voltage. Surface mount machines are simple in construction and make better use of permanent magnets compared to interior permanent magnet (“IPM”) machines. However, surface mount machines have less flexibility with regard to the operating point compared to the IPM machines. In a surface mount machine, L_{d} and L_{q} values are almost equal, therefore the same voltage requirement mentioned will lead to large current and low power factor. Due to the contribution of the reluctance torque, IPM machines may require lower current to produce the same output torque/power. So maximizing reluctance torque may be important for IPM machine design. Selecting the correct d & q axis electromagnetic circuits leads to higher ratio of L_{q} to L_{d}.

Accordingly, the disclosed configurations may increase the output torque for an IPM machine by introducing an intrusion into the air gap to maximize L_{q}. The disclosed configurations may also introduce an air wall to minimize L_{d} while keeping L_{q} intact.

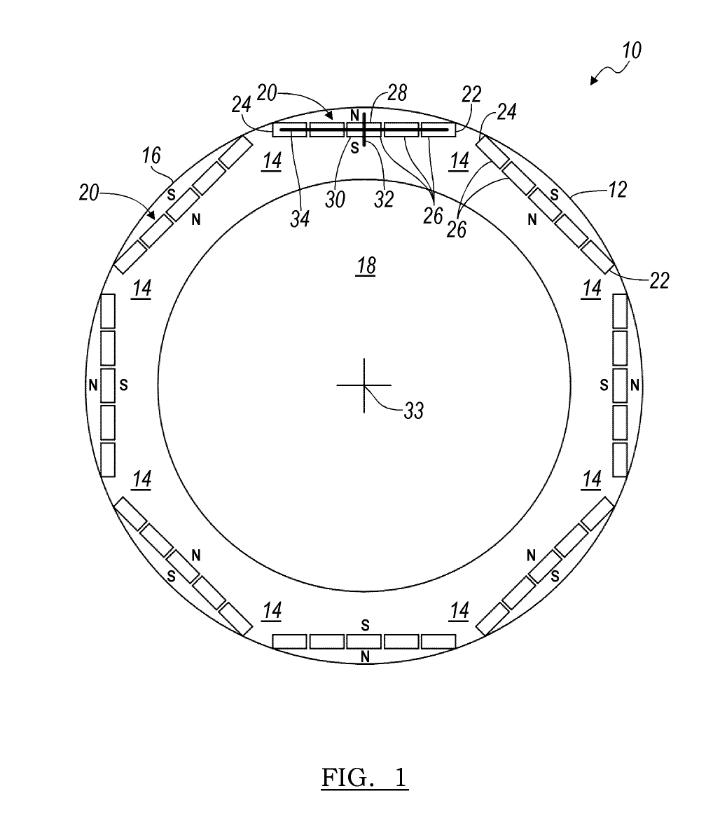

FIG. 1 illustrates a rotor 10 for an electric machine, such as an electric generator. The electric generator may be an embedded permanent magnet synchronous machine. The rotor 10 may be inside a stator. However, in other implementations, the rotor 10 may be situated outside the stator. In other implementations, the rotor 10 may be part of a semi surface mount machine. The rotor 10 may include a plurality of stacked rotor portions each shaped as a disk or generally shaped as a disk 12. Throughout each disk 12, the rotor 10 may include a magnetic region 14 that extends to an edge 16 (e.g. surface) of the rotor 10. The magnetic region 14 may be made of laminated steel or other magnetic materials. The interior 18 of the rotor 10 is not shown, but may include components necessary for proper operation of the electric generator.

The rotor 10 may have excitation magnetic field generating portions 20 disposed in holes of the disks 12. Any number of excitation magnetic field generating portions 20 may be used. The magnetic region 14 may surround the excitation magnetic field generating portions 20 to protect the excitation magnetic field generating portions 20 from centrifugal forces during rotation of the rotor 10, and from other forces.

Each excitation magnetic field generating portion 20 (e.g. poles) may have a first end 22 and a second end 24. A first end 22 of each excitation magnetic field generating portion 20 may be adjacent to a second end 24 of an adjacent excitation magnetic field generating portion 20.

Each excitation magnetic field generating portion 20 may have segmented magnets 26 arrayed in a row and positioned in plane with the rotor 10. One or any number of magnets 26 may be used in each excitation magnetic field generating portion 20, based on mechanical and/or manufacturing considerations. The magnets 26 may be permanent magnets, electromagnets (for example, a coil through which current is varied, thereby generating a magnetic field), or any other devices that generate magnetic fields, for example.

Each magnet 26 has a north and south magnetic poles 28, 30 that may lie along a radial direct axis 32 of the magnet 26. The radial direction may, for example, extend between the center 33 of the rotor 10 and the edge 16 of the rotor 10. Each magnet 26 also may define a quadrature axis 34, which may define an azimuthal boundary line between the north and south magnetic poles 28, 30, and which may be perpendicular to the respective direct axis 32 of the magnet 26. The azimuthal direction may, for example, extend circumferentially around the rotor, for example along a direction that passes through each of the magnetic generating portions 20. The azimuthal direction may be perpendicular to the radial direction.

Each of the magnets 26 in a given excitation magnetic field generating portion 20 may have identically oriented north and south magnetic poles 28, 30. Additionally, each excitation magnetic field generating portion 20 may have oppositely oriented north and south magnetic poles 28, 30 relative to an adjacent excitation magnetic field generating portion 20. Thus, the orientations of the north and south magnetic poles 28, 30 may alternate around the entire circumference of the rotor 10. This is possible if there is an even number of excitation magnetic field generating portions 20. If the magnets 26 are permanent magnets, then respective magnetizations of each excitation magnetic field generating portions 20 (and their constituent permanent magnets) may alternate between radially outward and radially inward around the circumference of the rotor 10.

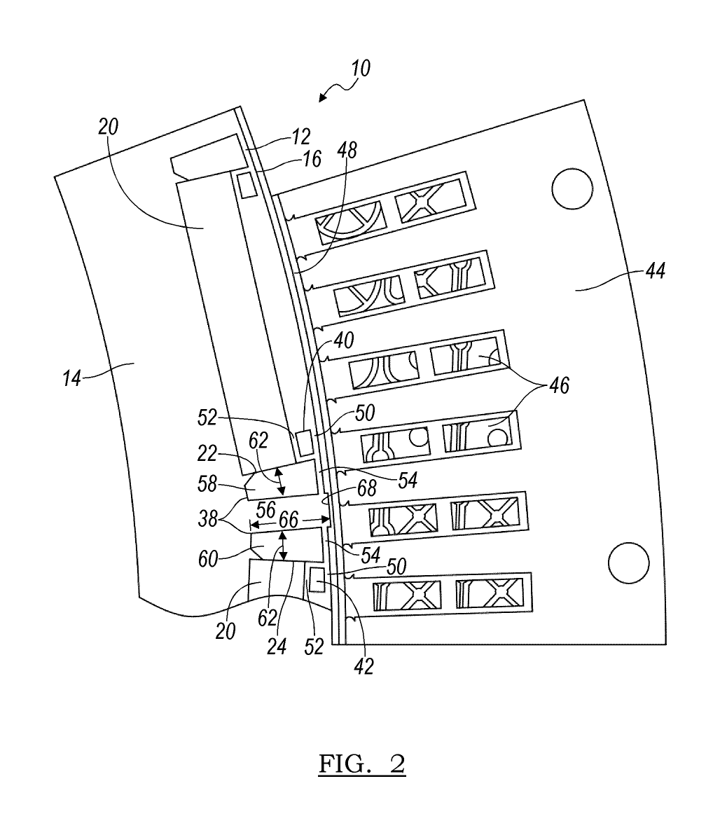

FIG. 2 illustrates a magnified view of the rotor 10 in an implementation having a number of non-magnetic regions 38, 40, 42 introduced into the rotor lamination. FIG. 2 also shows a stator 44 surrounding the rotor 10, armature coil windings 46 of the stator 44, and a gap 48 (e.g. air gap) located between the rotor 10 and the stator 44.

A first non-magnetic region 38 (e.g. a quadrature axis air hole) may be located between (e.g. azimuthally between) a first end 22 of a first excitation magnetic field generating portion 20 and the second end 24 of a second excitation magnetic field generating portion 20. Further, second and third non-magnetic region 40, 42 may respectively be located radially between the edge 16 and respective radial sides of excitation magnetic field generating portions 20 (e.g. above corners of the magnets 26). The second and third non-magnetic region 40, 42 may also respectively be located radially between the gap 48 and respective radial sides of respective magnets 26 of excitation magnetic field generating portions 20 (e.g. above corners 36 of the magnets 26). Thus, the edge 16 may be configured to be located adjacent to the gap 48, which may be adjacent to the stator 44. Although the excitation magnetic field generating portions 20 are shown as a single magnet 26 in FIG. 2 for simplicity, the excitation magnetic field generating portions 20 may have the structure shown in and described with respect to FIG. 1.

The first, second, and/or third non-magnetic regions 38, 40, 42 may be non-ferromagnetic regions, non-conductive regions (e.g. electrically non-conductive regions), a hole in the rotor, or filled with a non-magnetic material such as epoxy, for example. The first, second, and/or third non-magnetic regions 38, 40, 42 may have relative magnetic permeability values (μ/μ₀) of 1, about 1, or about the relative magnetic permeability value of air, for example. In some implementations, the first, second, and/or third non-magnetic regions 38, 40, 42 may instead be slightly magnetic regions having reduced relative magnetic permeability values compared to the relative magnetic permeability values of the surrounding magnetic regions 14 which are made of laminated steel. Further, as shown in FIG. 2, the first non-magnetic region 38 may have a polygonal (e.g. five-sided) shape or generally have a polygonal (e.g. five-sided) shape, and the second and/or third non-magnetic regions 38, 40, 42 may be have a quadrilateral (e.g. square) shape or generally have a quadrilateral (e.g. square) shape.

However, in other implementations, the first, second, and/or third non-magnetic regions 38, 40, 42, may have other shapes, for example a polygon or generally a polygon, triangle or generally a triangle, quadrilateral or generally a quadrilateral, square or generally a square, rectangle or generally a rectangle, pentagon or generally a pentagon, a hexagon or generally a hexagon, an octagon or generally an octagon, a circle or generally a circle, an oval or generally an oval, a teardrop or generally a teardrop, a trapezoid or generally at trapezoid, or an irregular shape.

Moreover, in some implementations, the first, second, and/or third non-magnetic regions 38, 40, 42 may each be split into two, three, four, or more non-magnetic regions that are spaced apart from each other by parts of the magnetic region 14. For example, the first, second and/or third non-magnetic region 38, 40, 42 may be comprised of two, three, four, or more radially spaced apart non-magnetic regions, or two, three, four, or more azimuthally spaced apart non-magnetic regions, or a 2×2 grid of non-magnetic regions 38.

In some implementations, the non-magnetic regions 38, 40, 42 may be surrounded by the magnetic region 14 of the rotor 10. As such, a first part 50 of the magnetic region 14 may be located between the non-magnetic region 40, 42 and the edge 16 of the rotor 10. Also, a second part 52 of the magnetic region 14 may be located between the non-magnetic region 40, 42 and a respective radial side of a magnet 26.

Opposing azimuthal sides of the non-magnetic region 38 may be flush with the first end 22 of a first excitation magnetic field generating portion 20 and a second end 24 of a second excitation magnetic field generating portion 20. In other implementations, a third part of the magnetic region 14 may be located between a first end 22 of a first excitation magnetic field generating portion 20 and a first azimuthal side of the non-magnetic region 38, and a fourth part of the magnetic region 14 may be located between a second end 24 of a second excitation magnetic field generating portion 20 and a second azimuthal side (opposing the first azimuthal side) of the non-magnetic region 38. Additionally, a fifth part 54 of the magnetic region 14 may be located between an outer radial side of the non-magnetic region 38 and the edge 16 of the rotor 10.

The non-magnetic regions 40, 42 may, for example, be optimized to block direct axis flux from the stator armature 46 without reducing main magnetizing flux from the excitation magnetic field generating portions 20 inside the rotor 10, as shown in more detail in U.S. patent application entitled “ROTOR LAMINATION STRUCTURE FOR PERMANENT MAGNET MACHINE” filed concurrently herewith, and the content of which is hereby incorporated by reference in its entirety.

Additionally, the rotor 10 may include an intrusion 56 (e.g. intruding piece, or extension). The intrusion 56 may divide the non-magnetic region 38 into two regions 58, 60 (e.g. airwalls). The intrusion 56 may be formed of laminated steel, for example. Including the intrusion 56 may change the saliency ratio, and also the direct axis and quadrature axis current requirements for certain terminal voltages. That is, current may be minimized for a given output torque/power by maximizing reluctance torque/power through increase of L_{q}/L_{d} ratio. The torque may be a function of the product of saliency ratio and the direct axis and quadrature axis currents.

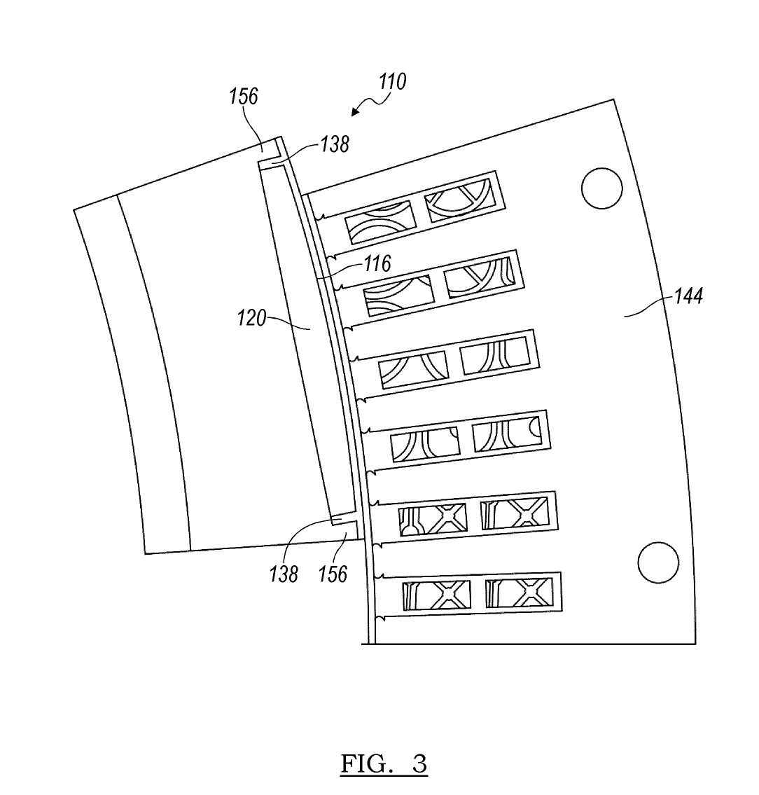

The configuration having the intrusion 56 and the regions 58, 60 may decrease leakage flux, thus increasing the magnet flux crossing the air gap. The distance between the excitation magnetic field generating portion 20 and the intrusion 56 may be selected to provide maximum torque output. The azimuthal widths 62 of the regions 58, 60 may be changed by adjusting the azimuthal width 64 of the intrusion 56. Smaller azimuthal widths 62 of the regions 58, 60 may create a large leakage of the magnet flux (increased leakage inductance), therefore reducing the fundamental alignment torque. A larger azimuthal width 62 of the regions 58, 60 may reduce the azimuthal width 64 of the intrusion 56, resulting in deeper saturation and reduction of the reluctance torque. In some implementations, an azimuthal width 62 of one of the regions 58, 60 may be larger than the azimuthal width 62 of another one of the regions 58, 60. A radial length 66 may be defined as beginning at an inward radial side of the non-magnetic region 38, and terminating at the outward radial end 68 of the intrusion. The outward radial end 68 may extend radially beyond the main magnetic portion 14 of the rotor 10, as shown in FIG. 3. Although the outward radial end 68 is shown having a rectangular or substantially rectangular shape, the outward radial end 68 may instead have a rounded shape or substantially rounded shape, or a triangular shape or a substantially triangular pointed shape that points radially outwardly, for example. Additionally, although only one intrusion 56 is shown in FIG. 3, two, three, four, five, or more intrusions 56 may be included in the non-magnetic region 38 in similar fashion to the one intrusion 56 shown. The choice of the number of intrusions 56 may depend on desired output torque and other characteristics, for example.

Tables 1 and 2 below illustrate analyses showing that introduction of the intrusion 56 in the non-magnetic region 38 has a significant impact on output torque in a 3.3 megawatt IPM machine.

Table 1 illustrates the difference in torque output with variation in azimuthal width of the quadrature axis intrusion 56. This comparison is based on a current of 3040 A rms at full load. As shown, the saliency ratio varies with the width of the regions 58, 60 (e.g. airwalls).

TABLE 1

| Intrusion | | | Average | Average | | Saliency |
|---|---|---|---|---|---|---|
| width | No load | Full load | torque | power | Ld, Lq (mH) | ratio |
| 19 mm | 599 V | 690 V | 90.52 kNm | 3.4125 MW | 0.22, 0.364 | 1.654 |
| | | | | (base) | | |
| 20 mm | 599 V | 690 V | 90.61 kNm | 3.4159 MW | 0.22, 0.375 | 1.704 |
| | | | | (0.1% more) | | |
| 21.2 mm | 599 V | 690 V | 90.82 kNm | 3.4238 MW | 0.221, 0.384 | 1.7375 |
| | | | | (0.33% more) | | |
| 22.2 mm | 599 V | 690 V | 90.7 kNm | 3.4193 MW | 0.22, 0.39 | 1.7727 |
| | | | | (0.2% more) | | |
| 23.2 mm | 599 V | 690 V | 90.75 kNm | 3.4208 MW | 0.222, 0.389 | 1.75225 |
| | | | | (0.24% more) | | |
| 24.2 mm | 599 V | 690 V | 90.87 kNm | 3.4257 MW | 0.22, 0.39 | 1.7727 |
| | | | | (0.386% more) | | |

Table 2 illustrates the difference is torque output with variation in outward radial length of the intrusion 56 into the non-magnetic region 38, assuming a 23.2 mm azimuthal width of the intrusion 56. As shown, the saliency ratio and hence the torque output increases with the increase in the outward radial length of the intrusion 56. With a 1.5 mm intrusion, a 1.16% increase in output power is predicted. Cogging torque and torque ripple values given without a skew in the rotor. With a skew of half slot pitch, the cogging torque value drops to less than 1% and the torque ripple to less than 2 for all cases.

TABLE 2

| Intrusion | No | Full | Cogging (80 | Torque ripple, | Avg. | Avg. | | Sal. |
|---|---|---|---|---|---|---|---|---|
| distance | load | load | C), no skew | no skew | torque | power | Ld, Lq (mH) | ratio |
| No | 599 V | 690 V | 3340 (3.82%) | 7200 (8.2%) | 89.7 kNm | 3.3816 MW | 0.221, 0.379 | 1.7149 |
| intrusion | | | <1% after skew | <2% after skew | | (base) | | |
| 1 mm | 599 V | 690 V | 3298 (3.76%) | 9860 (11.26%) | 90.46 kNm | 3.410 MW | 0.224, 0.392 | 1.75 |
| | | | <1% after skew | <2% after skew | | (0.84% more) | | |
| 1.5 mm | 599 V | 690 V | 3290 (3.76%) | 11380 (13%) | 90.75 kNm | 3.408 MW | 0.222, 0.389 | 1.75225 |
| | | | <1% after skew | <2% after skew | | (1.16% more) | | |
| 2.2 mm | 599 V | 690 V | 3250 (3.82%) | 13400 (15.3%) | 91.24 kNm | 3.4397 MW | 0.223, 0.393 | 1.7623 |
| | | | <1% after skew | <2% after skew | | (1.72% more) | | |

FIG. 3 illustrates a magnified view of the rotor 110 in a semi surface mount machine, for example. This implementation may include features similar or identical to the implementation of FIGS. 1 and 2, except for the following differences. The magnetic field producing portion 120 may be an inset magnet that defines the edge 116 of the rotor 110, and therefore there may be no non-magnetic regions analogous to the non-magnetic regions 40, 42. The inset magnet may cause a large loss in the rotor, thus the intrusion 156 may be formed of laminated steel. Further, it is noted that only a portion of the rotor 110 and stator 144 are shown in FIG. 3. The portions shown may be intended to be recur around the circumference of the rotor 110 and stator 114. As such, additional magnetic field producing portions 120 may be located adjacent to the magnetic field producing portion 120 shown.

Table 3 illustrates analyses showing that introduction of the intrusion 156 in the non-magnetic region 138 has a significant impact on output torque in a 3.3 megawatt surface mount or semi surface mount machine. Specifically, Table 3 illustrates various output torques for a surface mount machine and semi surface mount machine with various azimuthal widths between the magnetic field producing portion 120 and the intrusion 156. An azimuthal width distance of 5 mm from the magnetic field producing portion 120 gives the highest output torque. The comparison is based on the dimension of the machine for a power rating of 3.3 megawatts, like the IPM machine. Introduction of a 2 mm intrusion into the non-magnetic region 138 gives even higher torque output for the same current.

TABLE 3

| | Open | | | | |
|---|---|---|---|---|---|
| Inset | circuit | Terminal | | Reluctance | |
| dimension | voltage | voltage | Total torque | torque | Current |
| No inset | 599 V | 690 V | 89.665 kNm | 0 | 3270 A |
| | | | (base) | | |
| Inset with | 599 V | 690 V | 90.460 kNm | 0.795 kNm | 3270 A |
| 3 mm airwall | | | (0.88% | | |
| | | | more) | | |
| Inset with | 599 V | 690 V | 90.65 kNm | 0.985 kNm | 3270 A |
| 5 mm airwall | | | (1.086% | | |
| | | | more) | | |
| Inset with | 599 V | 690 V | 90.590 kNm | 0.925 kNm | 3270 A |
| 7 mm airwall | | | (1.021% | | |
| | | | more) | | |
| Inset with | 599 V | 690 V | 91 kNm | 1.335 kNm | 3270 A |
| 5 mm airwall | | | (1.467% | | |
| with 2 mm | | | more) | | |
| intrusion | | | | | |

Although in FIGS. 1-3 the magnetic regions 38, 138 and the intrusions 56, 156 may be near an edge of a rotor 10, 110, with the rotor 10, 110 being located inside the stator 44, 144, the present disclosure is meant to encompass other structures as well. For example, the non-magnetic regions 38, 138 and intrusions 56, and 156 may be near an edge of a rotor 10, 110 and adjacent to the stator 44, 144, with the rotor 10, 110 being outside of the stator 44, 144.

As a person skilled in the art will readily appreciate, the above description is meant as an illustration of the principles of this application. This description is not intended to limit the scope or application of this invention in that the invention is susceptible to modification, variation and change, without departing from spirit of this application, as defined in the following claims.

1. A rotor for an electric machine, the rotor comprising:
a magnet;
a non-magnetic region located adjacent to the magnet; and
an intrusion extending into the non-magnetic region.

2. The rotor of claim 1 wherein the non-magnetic region is an electrically non-conductive region.

3. The rotor of claim 1 wherein the non-magnetic region is a hole in the rotor.

4. The rotor of claim 1 wherein the non-magnetic region is filled with epoxy.

5. The rotor of claim 1 wherein the intrusion is formed of a magnetic material.

6. The rotor of claim 1 wherein the intrusion is formed of electrically conductive material.

7. The rotor of claim 1 wherein the intrusion extends across the non-magnetic region in a radial direction.

8. The rotor of claim 1 wherein the non-magnetic region has a first region adjacent to a first azimuthal side of the intrusion and a second region adjacent to a second azimuthal side of the intrusion.

9. The rotor of claim 1 wherein the rotor is positioned relative to a stator to form an gap between an edge of the rotor and the stator, the intrusion extending radially from the edge of the rotor into the gap.

10. The rotor of claim 1 further comprising a second non-magnetic region located radially between the magnet and an edge of the rotor.

11. The rotor of claim 1 further comprising a magnetic region located between the non-magnetic region and the edge of the rotor.

12. A rotor for an electric machine, the rotor having an edge configured to be located adjacent to an air gap that is adjacent to a stator, the rotor comprising:
a first magnet;
a second magnet;
a non-magnetic region located between a first end of the first magnet and a second end of the second magnet; and
an intrusion extending radially from the edge and into the non-magnetic region and into the air gap.

13. The rotor of claim 12 wherein the non-magnetic region is an electrically non-conductive region.

14. The rotor of claim 12 wherein the non-magnetic region is a hole in the rotor.

15. The rotor of claim 12, wherein the non-magnetic region is filled with epoxy.

16. The rotor of claim 12 wherein the intrusion is formed of a magnetic material.

17. The rotor of claim 12 wherein the intrusion is formed of an electrically conductive material.

18. The rotor of claim 12 wherein the non-magnetic region has a first region adjacent to a first azimuthal side of the intrusion and a second region adjacent to a second azimuthal side of the intrusion.

19. The rotor of claim 12 further comprising:
a second non-magnetic region located radially between the first magnet and an edge of the rotor; and
a third non-magnetic region located radially between the second magnet and the edge of the rotor.

20. A rotor structure configured to increase reluctance torque, the rotor structure including an intrusion in a non-magnetic region that is located between two magnets.
